(19) United States
(12) Patent Application Publication
(10) Pub. No.: US 2005/0257975 A1
(43) Pub. Date: Nov. 24, 2005

(54) Expressway safety mirror

(76) Inventor: John C. Cavin, Rockledge, FL (US)

Correspondence Address: JOHN C. CAVIN, 1886 BARRINGTON CIRCLE, ROCKLEDGE, FL, 32955, US

(21) Appl. No.: 10/849,358

(22) Filed: May 19, 2004

(51) Int. Cl. B62D 1/24

(52) U.S. Cl. 180/169

(57) ABSTRACT

An automobile on an interstate highway equipped with an Expressway Safety Mirror would warn the driver of an automobile approaching from the rear and its speed, time in seconds before being overtaken. A red light would flash on the face of the mirror indicating that the approaching autombile was too close and it would be usafe to swap lanes. A green light on the face of the mirror would indicate it is safe to swap lanes because the closing speed and distance were in a safe range. The Expressway Safety Mirror would prevent a driver on an interstate highway from moving over into the path of an automobile approaching from the rear at a higher rate of speed. The driver would be alerted to a potential crash. The Expressway Safety Mirror would prevent accidents and save lives.

### CROSS REFERENCE TO RELATED APPLICATION

Not applicable

### STATEMENT REGARDING FEDERALLY SPONSORED RESEARCH

Not applicable

### REFERENCE TO MICROFICHE APPENDIX

Not applicable

### BACKGROUND OF THE INVENTION

This invention is in response to the continued frequency of automobile accidents on the interstate highways due to drivers in the right lane pulling into the left lane to pass the automobile in front of them, therefore causing an accident because they pulled into the path of an automobile in the right lane that was overtaking them. The driver's side rear view mirrors presently available don't display the speed or number of seconds the automobile approaching from the rear in the left lane is traveling or will overtake said automobile. The driver's side rear view mirrors presently available don't have a blinking red light to warn the driver and alert him/her of the approaching automobile from rear left lane.

### BRIEF SUMMARY OF THE INVENTION

This invention is a driver's side rear view mirror that attaches to an automobile and gives the driver a view of the automobiles approaching from the rear left hand lane on an interstate highway. The mirror is equipped with a radar beam or laser beam that will give the driver a digital readout of the speed of the automobile approaching from the rear and the number of seconds until he/she is overtaken. When the automobile approaching from the rear is 5 seconds away from overtaking, a red light on the mirror starts to flash, indicating that it is too dangerous to pull into the left lane. This will alert the driver to the possiblilty of a crash. If the driver has not been paying attention to the automobile approaching from the rear, when the red light starts to blink, he/she can compare the speed of the automobile approaching from the rear and his/her speed. This will alert them to the difference in the speed of the two vehicles and prevent them from pulling out in front of the approaching automobile thereby preventing an accident.

### BRIEF DESCRIPTION OF THE DRAWINGS

I, John C. Cavin, have created a new automobile driver's side rear view mirror as shown in the accompanying drawings, in which:

FIG. 1 shows the front face of the mirror, which shows the radar or laser box on the outside left side of the mirror. This is where the radar or laser sending unit and receiving unit is housed, with the Global Positioning Satellite receiver on top of the unit. FIG. 1. also shows the digital window for approaching automobile's speed, the digital window that displays the number of seconds that the automobile approaching from rear will overtake, and the red and green lights.

FIG. 2. is a perspective, right side view of the mirror, which shows the mirror's attachment that will attach the mirror to the automobile.

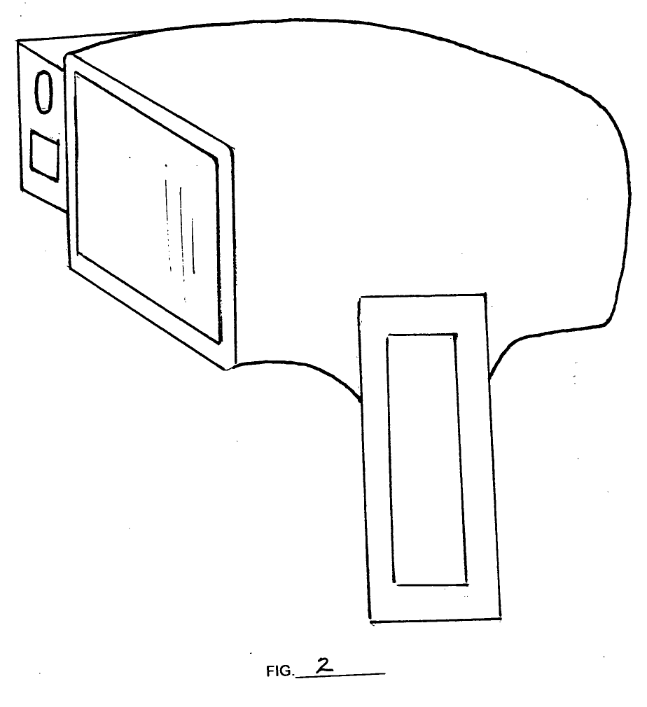

FIG. 3. is a perspective, left side view of the mirror, which shows the side the radar or laser housing is on and the Global Positioning Satellite receiver on top of the housing.

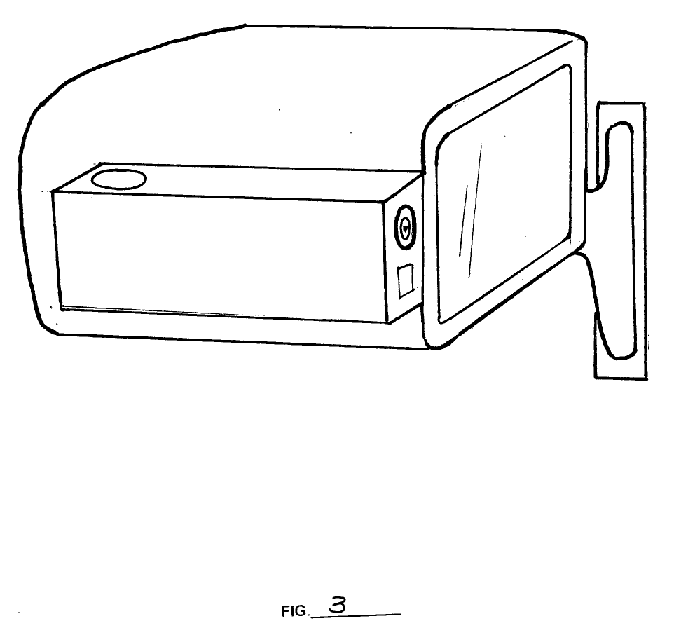

FIG. 4. is a rear view of the mirror, which shows the attachment that will attach the mirror to the automobile and the radar or laser housing box with the Global Positioning Satellite receiver on top of the housing.

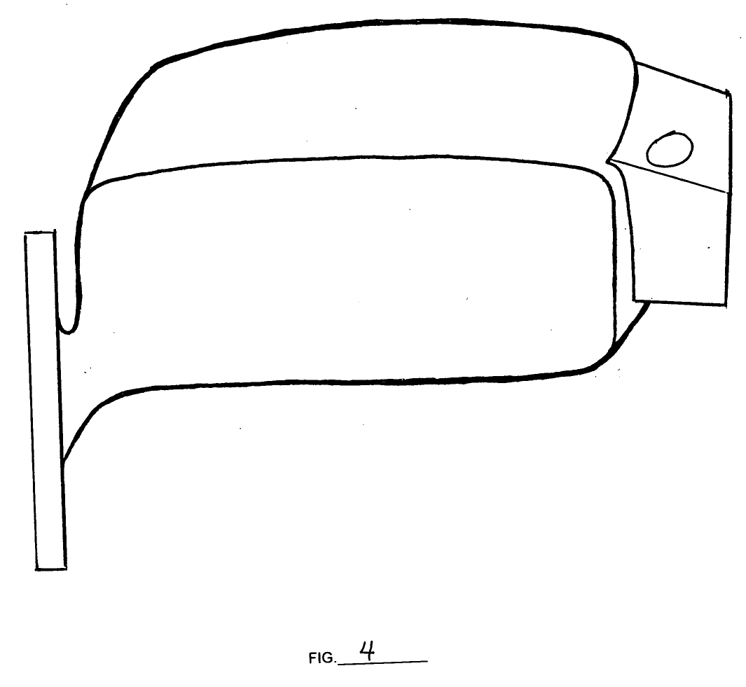

### DETAILED DESCRIPTION OF THE INVENTION

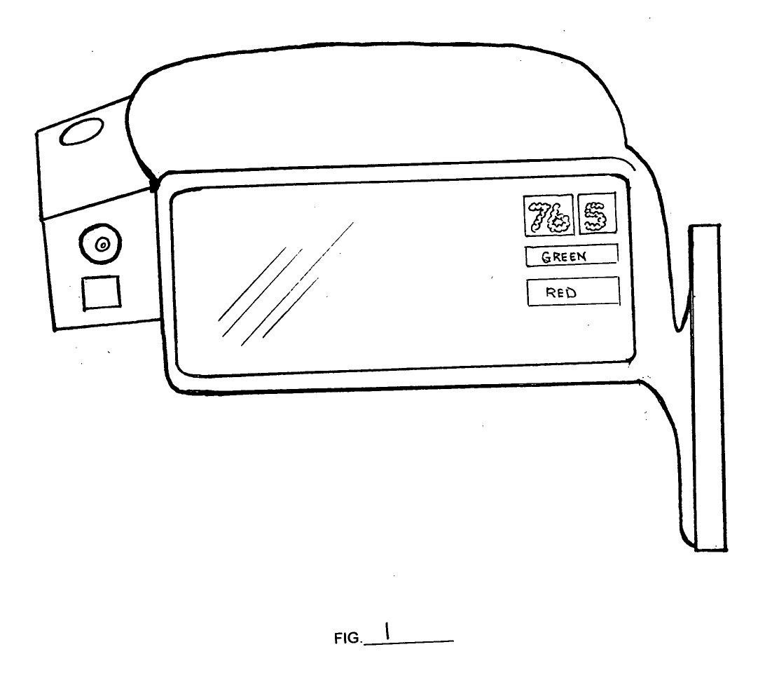

This invention combines a radar beam or laser beam with an automobile outside rear view mirror on the driver's side to become a new visual recording device. The radar beam or laser beam is aimed to the rear of the automobile from the mirror. If the automobile is in the right lane of an interstate highway or expressway, the beam is directed to the left lane behind the automobile. The beam hits an automobile in the left lane and bounces back to the mirror where a receiver picks up the beam. The receiver then translates the speed of the automobile approaching from rear to a digital readout gauge on the outside face of the mirror. The receiver also translates how many seconds before the automobile approaching from the rear overtakes the automobile with the Expressway Safety Mirror. The number of seconds is also flashed on a digital readout gauge on the outside face of the mirror. The driver of the automobile with the Expressway Safety Mirror knows he/she has an automobile approaching from the rear in the left lane that is running 76 M.P.H. and will pass him in 5 seconds as shown in FIG. 1 in the drawings. At this point a red light will flash on a digital gauge on the face of the mirror which lets the driver know that the automobile approaching from the rear is in a danger zone and too close for him/her to change lanes. If the seconds is more than 10, the mirror would flash a green light which would let the driver know the automobile approaching from the rear is in the safety zone and he/she can pass or change lanes safely.

The Expressway Safety Mirror has a on off switch which enables the driver to control when he/she wants the information. When the driver is not on the interstate or expressway he/she can turn the Expressway Safety Mirror off and it works just as a rear view mirror. The power source to operate the radar or laser beam, receiver, G.P.S., digital gauges and lights will be the battery of the automobile to which the Expressway Safety Mirror is attached. A Global Positioning Satellite receiver on the Expressway Safety Mirror is constantly communicating with the ring of satellites located above the earth's atmosphere. This gives the Expressway Safety Mirror vital information about its location, speed and direction on the earth's surface. This information is fed to the radar or laser receiver to locate the beam in relation to the automobile approaching from the rear. Either a radar beam or a laser beam could be used to operate the Expressway Safety Mirror successfully. That choice would be made at the time of manufacture based on economics.

1. A radar or laser activated automobile driver's side rear view mirror which will record, digitally, the speed of the approaching automobile from the rear and display the speed on the face of the mirror.

2. A radar or laser activated automobile driver's side rear view mirror which will record, digitally, and display on the face of the mirror the number of seconds an automobile approaching from the rear will overtake the automobile with said mirror.

3. A radar or laser activated automobile driver's side rear view mirror which will display a red light on the face of the mirror when the approaching automobile from the rear is deemed to be, by speed and number of seconds to overtake, a danger if driver of automobile with said mirror wanted to execute a pass on automobile in front by swapping lanes.

4. A radar or laser activated automobile driver side rear view mirror which will display a green light on the face of the mirror when the approaching automobile from the rear is deemed to be, by speed and number of seconds to overtake, a safe distance away if the driver of the automobile with said mirror wanted to execute a pass on automobile in front by swapping lanes.

5. A radar or laser activated automobile driver side rear view mirror which has a Global Positioning Satellite receiver which will locate the radar or laser beam in relation to the automobile approaching from the rear.
